(19) United States
(12) Patent Application Publication
(10) Pub. No.: US 2025/0006011 A1
(43) Pub. Date: Jan. 2, 2025

(54) LIVE GAMING APPARATUS WITH DICE SHAKER AND GAMING WHEEL

(71) Applicant: INTERBLOCK D.O.O., MENGES (SI)

(72) Inventor: John Joseph CONNELLY, LAS VEGAS, NV (US)

(21) Appl. No.: 18/645,283

(22) Filed: Apr. 24, 2024

Related U.S. Application Data
(60) Provisional application No. 63/511,104, filed on Jun. 29, 2023.

(51) Int. Cl. G07F 17/32

(52) U.S. Cl. CPC G07F 17/3288; G07F 17/3209; G07F 17/3213; G07F 17/3216; G07F 17/3267

(57) ABSTRACT

The present disclosure relates to systems and methods for live gaming with dice and roulette systems. Various embodiments may include a gaming apparatus comprising a dice shaker and a gaming wheel providing a plurality of outcomes. Examples may be configured to activate the dice shaker to generate a roll outcome and activate the gaming wheel based on the roll outcome. The results of the gaming wheel may apply a multiplier to the gaming event. The dice shaker and gaming wheel elements may include physical and/or virtual elements associated with the gaming apparatus.

### CROSS REFERENCE TO RELATED APPLICATION

This application claims benefit under 35 U.S.C. § 119(e) of Provisional U.S. Patent Application No. 63/511,104, filed Jun. 29, 2023, the contents of which is incorporated herein by reference in its entirety.

### TECHNICAL FIELD

The present disclosure relates generally, but not exclusively, to the field of gaming, particularly dice and roulette games.

### BACKGROUND INFORMATION

Casinos and gaming locations offer a variety of games to attract players. Such games may include live table games, traditional casino games (e.g., roulette, craps, blackjack, etc.), virtual games, physical machines (e.g., slot-like machines), individual gaming apparatus, stadium-style group stations, and various gameplay combinations.

Many players enjoy playing at a particular casino or gaming location or at a particular machine but may also desire variety in their gaming experience. Player familiarity with a game may cause a decrease in player interest and engagement.

Accordingly, casinos and gaming locations have an interest in increasing player interest and engagement opportunities, which may result in more gaming, greater profits, and player loyalty. Casinos and gaming providers must therefore continuously innovate to attract and retain players, maintain profitability, and improve player experience.

### SUMMARY

An embodiment is directed to systems and methods for live gaming on gaming apparatuses comprising a dice shaker and a gaming wheel. Aspects may include a processor and at least one memory to cause the gaming system to activate the dice shaker to generate a roll outcome, activate the gaming wheel using a movement characteristic based on the roll outcome, and determine a randomized outcome of the gaming wheel. In some examples, a multiplier corresponding to the randomized outcome may be applied to the gaming event. Various gaming events, gaming techniques, multipliers, bonuses, and wager resolutions may be provided using aspects and embodiments discussed herein.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagrammatic, perspective view of an example base of a gaming apparatus, in accordance with an embodiment.

FIG. 2 is perspective view of a gaming apparatus providing virtual dice and roulette gameplay, in accordance with an embodiment.

FIG. 3 is a diagrammatic, perspective view of an example gaming apparatus with a dice shaker and roulette wheel, in accordance with an embodiment.

FIG. 4 is a diagrammatic, perspective view of an example gaming apparatus with a dice shaker, roulette wheel, and additional display, in accordance with an embodiment.

FIG. 5 is a flowchart for live gaming operations, in accordance with an embodiment.

FIG. 6 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and computer readable storage media for gaming systems and live gaming techniques using a dice shaker and gaming wheel. According to various aspects, players may interact with a gaming apparatus that includes a dice shaker and a gaming wheel. The dice shaker may be a physical dice shaker including one or more die. Dice shakers may include a movable platform to shake, roll, and toss dice, as discussed herein. The gaming wheel may be a roulette wheel, such a standard roulette wheel, a spinning wheel, a virtual wheel, and the like. In an embodiment where the gaming wheel is a roulette wheel, activation of the gaming wheel may cause a ball to be launched into the roulette wheel, and the gaming wheel outcome may correspond to a pocket in which the ball lands.

Such live gaming systems may determine multipliers and generate gaming outcomes based on one or more combinations of dice rolls and gaming wheel spins. Such gaming events may provide unique gaming experiences through a combination of dice shaker and gaming wheel operations. Gaming events may include one or more rounds of play that incorporate a dice roll and gaming wheel outcome. In any or all embodiments, such gaming techniques may ensure randomness of gaming events and gaming outcomes.

In an example with a gaming apparatus including a dice shaker and gaming wheel, a dice roll may determine a speed of a ball launch into a roulette wheel, or a speed of a multiplier gaming wheel. One or more gaming controllers may receive input, e.g., from a live player, to determine at least one of a timing of a dice roll, and a force of the dice roll. For example, a bash button may be connected to the gaming apparatus, and a player may hit the bash button to initiate a dice roll. The bash button may include one or more force sensors and/or pressure sensors. The force at which the button is hit (also referred to herein as an “activation force”) may determine when the dice are rolled and/or how hard the dice are thrown. Regardless of the player actions and player input, gaming events and outcomes may remain randomized.

Some gaming establishments may create a dedicated gaming floor or gaming area for the gaming apparatuses and gaming techniques discussed herein. For example, a set of gaming apparatuses providing gaming events incorporating both dice outcomes and gaming wheel outcomes may be located in a room, such as a casino pit, a warehouse, or another area. In some examples, a gaming apparatus may be operable in-person, remotely, or both.

The gaming techniques and examples discussed herein enable gaming establishments to accommodate various player preferences and provide a creative combination of popular games. These techniques may encourage and increase gaming, player entertainment, player satisfaction, and overall profitability, among other benefits.

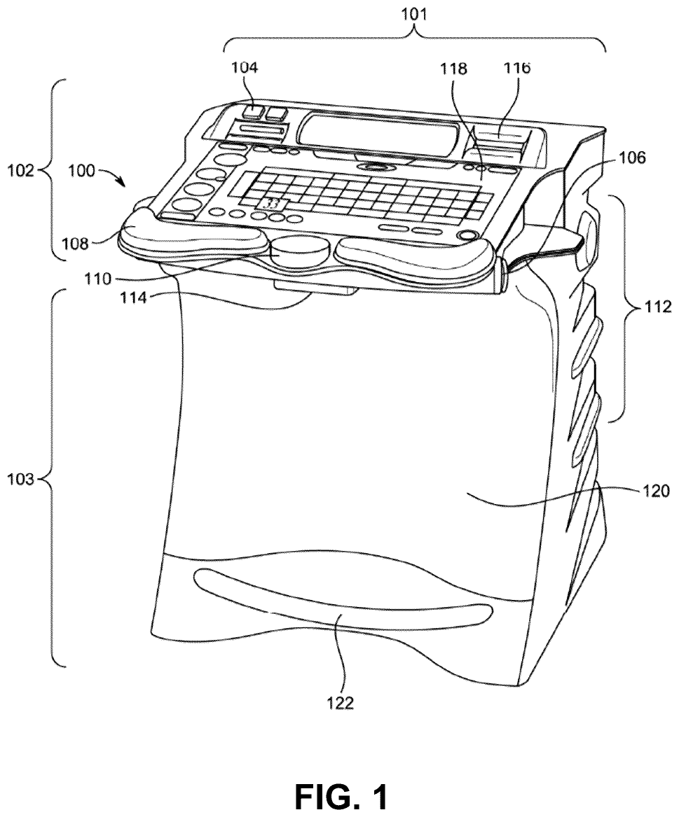

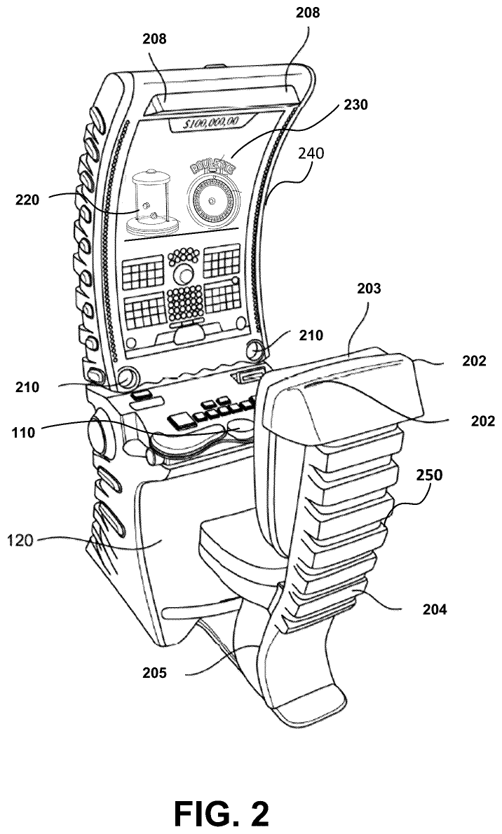

FIG. 1 illustrates a base of a gaming apparatus in accordance with various aspects of the present disclosure. According to some examples, the gaming apparatus may include a universal cabinet. In some universal cabinet configurations, different games may be connected to a top 101 of an upper section 102 of the base 100. The base 100 may include a lower section 103 on which the upper section rests. As further illustrated in FIGS. 2-4, the gaming apparatus may include a number of exterior elements that provide visual and audio effects. Such exterior elements may serve to attract attention to the game, so as to entice someone passing by to play a game offered by the universal cabinet, or to enhance the play of a game being played at the gaming apparatus.

The exterior elements may include soft touch gel buttons, such as buttons 104 and 106, gel arm rests 108 at the bottom of the upper section 102 where a player's arms would rest for extended periods of time, and a control button 110 that may be usable for different games. Other lighting effects that may be provided include gel LED modules 112 of different sizes and shapes and an ambient LED 114 that illuminates the bottom section 103 from underneath the upper section 102. The upper section 102 may further include a money/credit/card receiving/payout mechanism 116 and a display 118. Speakers 120 in the lower section 103 may provide some or all of the sound, depending on the nature of the game being played. A footrest 122 may also be built into the lower section 102.

The inside of the universal cabinet may include a controller module that may provide common connections for each of the different types of toppers and provide a USB connection to an embedded computer (not shown) in the bottom section 103. The embedded computer may be a GANLOT AMDY-7005, which is designed for gaming applications. The controller module may also provide outputs for the base cabinet lighting and buttons, which makes it possible to offer numerous gaming machine lighting designs. The controller module may also make it possible to quickly change toppers on the base 100. Only the upper section 102 may need to be removed to access the controller module. Connections from the existing topper may be disconnected and the topper removed from the upper section 102. The new topper may then be attached to the upper section 102 and its connections plugged into the controller module. In an embodiment, a switch in the controller module may then be switched to correspond to the new topper. In other embodiments, the new topper can be identified by connecting or plugging one or more additional modules for that topper into the controller module or changing a program of the embedded computer. This may make it possible to quickly change the type of game that is being played on the universal cabinet base 100 without have to remove the base 100 from any row it is in and without moving other machines or forcing the other machines to be shut down. This may also make it possible to prototype and develop other toppers for new games, further reducing development and production costs.

FIG. 2 further illustrates the base 100 of the gaming apparatus when a seat 250 and a tall, curved display topper 240 have been connected. The display topper 240 may include one or more physical, visual, and/or virtual elements to provide gameplay for a variety of betting and casino games, including but not limited to poker, craps, roulette, blackjack, slots, other card games, dice games, and video games.

As shown in FIG. 2, the gaming apparatus may include a virtual display of a dice shaker 220 and gaming wheel 230. The virtual dice shaker 220 and gaming wheel 230 may be operable using control button 110, which may serve as a bash button, as discussed herein. The control button 110 may, for example, initiate a gaming event, a virtual dice throw, a spin of the virtual gaming wheel 230, or a signal to stop or slow the virtual gaming wheel 230. The virtual dice shaker 220 and virtual gaming wheel 230 may be displayed at various positions on the display topper 240, depending on the gaming event.

In addition to the speakers 120 built into the lower section 103 of the base 100, such as a 50 Watt/4 Ohm subwoofer speaker, the seat 250 may include additional speakers 202, such as two 25 Watt/8 Ohm speakers in an upper section 203 of the seat 250. Additional speakers may be included in the topper 240, such as two 25 Watt/8 Ohm speakers 208 at the top of the topper 240 and two 25 Watt/8 Ohm speakers 210 at the bottom of the topper 240. In addition to those speakers, a 50 Watt/4 Ohm rumble speaker 204 may be provided in the bottom section 205 of the seat 250. This many speakers may enable a variety of audio effects, especially if a range of speaker types are used, including tweeters, midranges and subwoofers or woofers.

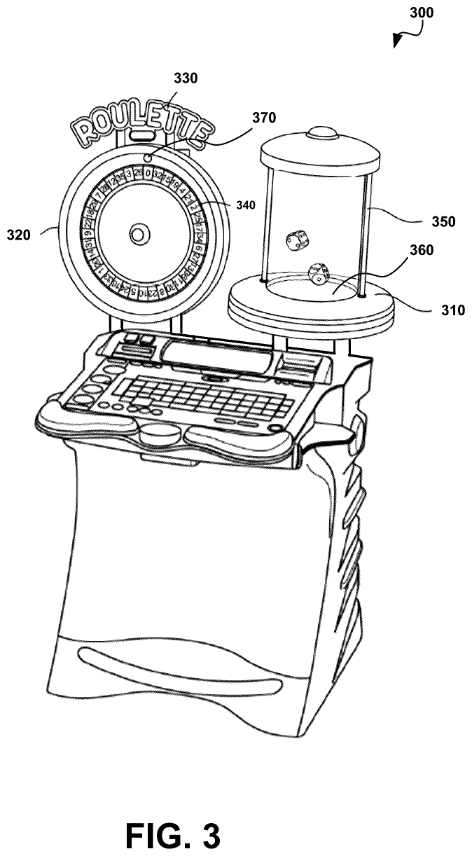

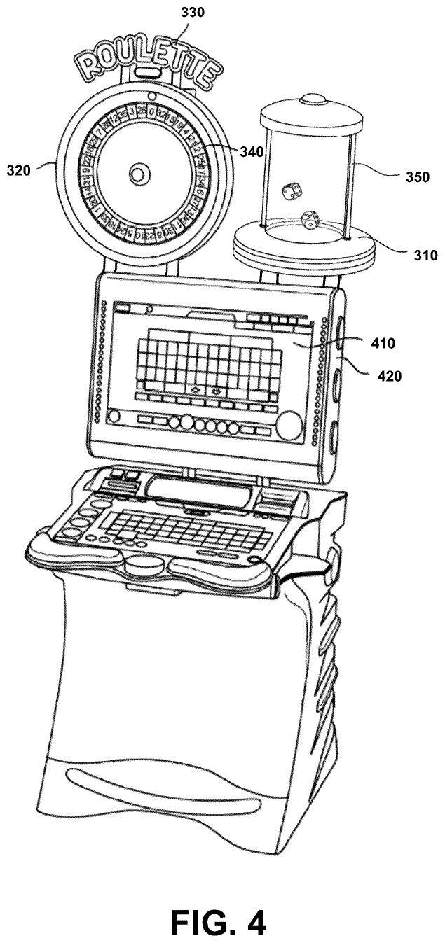

FIGS. 3-4 illustrate gaming apparatuses having a physical dice shaker 310 and roulette wheel 320. FIG. 3 illustrates a gaming apparatus with a dice shaker and a roulette wheel mounted on a universal base. FIG. 4 illustrates a configuration having a display system 420, a user interface 410, a roulette wheel 320, and dice shaker 310. Additional toppers may be added to the universal base 100, as previously discussed. Various styles and arrangements, including but not limited to standard player cabinets, and machines with or without removable toppers, may fall within the scope of various aspects and embodiments discussed herein.

A dice shaker 310 may enable a variety of additional gaming events to be played, such as craps, sic-bo, and other types of dice games. The dice shaker 310 may include a cage 350 to contain the dice, and a platform 360 to activate dice rolls. In some examples, the platform 360 may be configured to roll dice at various speeds and intensities. For example, the platform may launch the dice upwards at a speed corresponding to at least one of a timing and a force associated with the bash button. A soft hit of the bash button may cause a dice launch at a first force, whereas a hard hit of the bash button may cause a dice launch at a second force greater than the first force. The force of the dice launch may correspond to a speed at which the platform moves upwards to throw the dice.

The dice may include at least one radiofrequency identification (RFID) tag, such as a RFID tag associated with each side. An RFID reader may be placed within or beneath platform 360 to detect an outcome of the dice roll. In some examples, the gaming apparatus may include a random generator (not shown) for controlling the randomness of the dice roll in order to make a game fair. In some examples, a dice throw may be randomly affected by a random generator in the base.

The gaming wheel 320 may be an additional topper provided on a base of the gaming apparatus. In some embodiments, the gaming wheel is a vertical roulette wheel including signage 330 to identify the type of wheel. The gaming wheel may also display a plurality of outcomes 340. The outcomes 340 may correspond to outcomes present on a standard roulette wheel. The gaming wheel 320 may spin and/or include one or more lighting elements and physical elements to simulate or indicate a spin. For example, outcomes 340 may independently and sequentially light up to indicate a wheel spin. The wheel may also have at least one topper element to slow a spin and/or a marker element to indicate an outcome of the gaming wheel.

In an embodiment where the gaming wheel is a roulette wheel, a roulette ball 370 may be configured to spin around a rim of the gaming wheel. In some examples, each outcome may correspond to a pocket on the gaming wheel, and the outcome of a gaming wheel spin is the pocket in which the roulette ball lands. Although FIGS. 3 and 4 illustrate a vertical gaming wheel, a horizontal gaming wheel, such as a standard roulette wheel orientation, may be provided in connection with the gaming apparatus.

In various embodiments, at least one peripheral may be connected to the user device to enhance the gaming experience. For example, a device, controller, or the bash button may be directly or remotely connected to the gaming apparatus. Such peripherals may allow players to initiate certain gaming events, such as a dice throw or wheel spin. Other types of peripherals may be applicable, based on the gaming apparatus and/or game type. In some examples, the peripheral may be connected through a Universal Serial Bus (USB). In another example, a card reader may be connected to the user device, to enable users to add funds, log in, or access loyalty programs, discounts, free games, and the like.

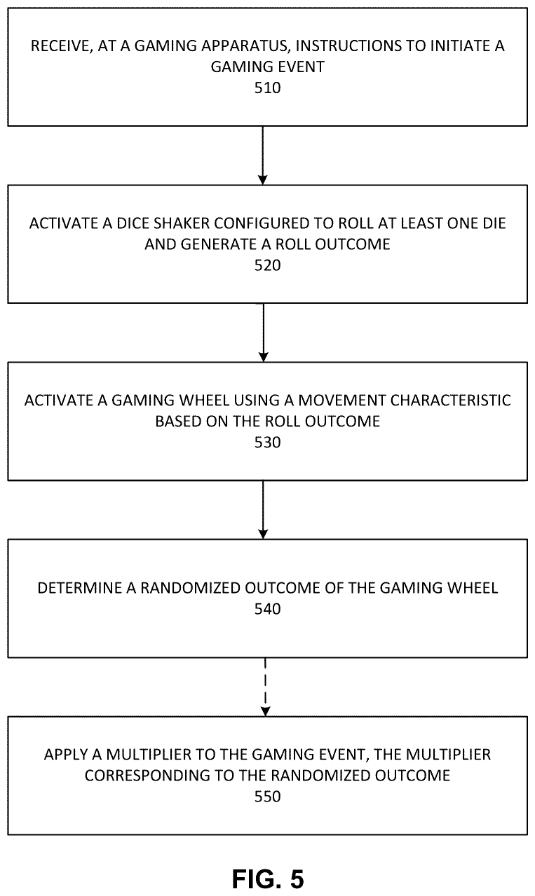

FIG. 5 provides a flowchart of a live gaming operations, in accordance with various aspects. Such operations may occur using one or more computing devices, including a processor and memory. Various techniques may utilize one or more cameras, user devices (e.g., cell phone, smartphone, PC, gaming device, etc.), or applications operating on a user device or other computing device. Gaming apparatuses may be an individual player machine, which may be a standalone machine or connected to one or more other gaming devices and gaming apparatuses.

At block 510, aspects may receive, at a gaming apparatus, instructions to initiate a gaming event. The gaming event may be any of a plurality of casino games playable on the gaming apparatus. Player input received at the gaming apparatus may generate the instructions to initiate the gaming event. In various examples, player input may be provided via one or more interactions with the gaming apparatus, through a physical button, peripheral, selection, or other means to interact with the gaming apparatus. In some examples, dice shakers and gaming wheels associated with the gaming apparatus may be virtual and provided on a display associated with the gaming apparatus. In other examples, dice shakers and gaming wheels may be physical systems, connected the gaming apparatus.

The gaming event may include one or more rounds of play. A round of play may include at least one of activating the dice shaker and activating the roulette wheel. In some examples, a combination of outcomes from the dice shaker and the roulette wheel may determine a result for a round of play. As discussed herein, results from a first device (e.g., the dice shaker or the roulette wheel) may initiate activation of a second device (e.g., the dice shaker or the roulette wheel). A game result may be determined from one or more rounds of play.

In some examples, a round of play may be played locally or remotely. Local games may, for example, be initiated using a player machine, as described in FIGS. 2-4. A player may operate the player machine to initiate a round of play. In other examples, the player machine (see, e.g., FIGS. 2-4) may be viewed or accessed remotely. A remote device (e.g., a remote player machine, a remote computing device, etc.), may enable betting for one or more rounds of play. In some examples, the remote device may remotely control aspects of the player machine, to initiate gaming actions, such as starting a round of play, activating the dice shaker, activating a launch of a roulette ball, and the like.

At block 520, aspects may activate a dice shaker configured to roll at least one die and generate a roll outcome. In some examples the dice shaker may be automatically activated during the gaming event, such as in response to the gaming event being initiated, or at a particular time during the gaming event, such as during a round of play. In some examples, the dice shaker may be activated by one or more of: a result of the gaming wheel, a prior dice shaker result, and a combination or one or more prior results. A round of play, for example, may include multiple dice shaker activations, which may be initiated manually, in response to player input and/or automatically.

The roll of at least one die may occur virtually, e.g., on a display, or physically. In either case, the roll may occur in real-time, e.g., in response to an activation input, or at a predetermined period of time during the gaming event. Regardless of whether a dice roll occurs via a virtual or physical device, any dice roll actions and display of results simulate a live gaming event, with game play actions and results occurring in real-time. Such timing results in a live gaming experience, promotes excitement and interest, and simulates control of the gaming event by the player. Such real-time actions, visuals, and results display may also apply to gaming wheel operations, virtual play operations, and any display videos and animations, which may correspond to the gaming event.

As discussed herein, the dice shaker may be activated in response to player input received at the gaming apparatus. Player input may include, for example, manipulation of a physical button or a selection of a virtual button to activate the dice shaker. The dice shaker may be activated in response to input received at a bash button or other controller peripheral in communication with the gaming apparatus.

The controller may measure an activation force corresponding to a measured force associated with received player input. The activation force may be measured via one or more sensors, including but not limited to an image sensor, a proximity sensor, a light sensor, a pressure sensor, and a radio frequency identification sensor.

In some examples, a harder hit of the controller (e.g., a bash button) may result in dice thrown with greater speed or force than a softer hit. A timing of the player input may affect at least one of a speed, timing, or force of the dice throw. In some examples, a timing of the dice throw corresponds to a gaming event. The timing and/or force of the player input for the dice throw may be beneficial, detrimental, or have no effect on the dice roll outcome or gaming event outcome. In some embodiments, dice rolls may be randomized regardless of player input. In an example, the roll outcome may be generated using a random number generator, with the dice shaker and/or display configured to display a result corresponding to the roll outcome. This can ensure randomness and fairness despite player interaction. Such techniques may prevent players from gaining an advantage or affecting gaming outcome probabilities. As discussed above, the dice roll outcome may be determined automatically. In some examples, at least one RFID tag associated with physical dice may assist with the roll outcome determination. For example, the one or more die may land in an area or on a surface including an RFID tag reader, which can identify one or more RFID tags associated with a die. The RFID tag reading may determine a nearest surface of the die, and based on the die's known shape and labeling, the die roll outcome may be determined. In some examples, an inconclusive roll outcome or error may result in a reactivation of the dice shaker, or other secondary action to generate the roll outcome.

At block 530, aspects may activate a gaming wheel using a movement characteristic based on the roll outcome. Movement characteristics may include, but are not limited to a wheel rotation speed, a ball launch speed, a timing of the ball launch, a number of balls launched, and the like. In an example, wherein the movement characteristic relates to a ball launch speed, a lower number or value of the roll outcome may result in a slower ball launch speed, while a higher number of value of the roll outcome may correspond to a faster ball launch speed. In other examples, the roll outcome may affect a spin speed of the gaming wheel, wherein a higher value corresponds to a higher spin speed. Any combination of roll outcomes and speed correlations may be applied. For example, a higher roll outcome may correspond to a lower speed. The roll outcome may also affect multiple movement characteristics of the gaming wheel. For example, multiple balls may be launched onto the gaming wheel, with a timing and/or speed associated with the roll outcome.

The gaming wheel activation may occur automatically, such as at a specified timing after the determination of the dice roll outcome. For example, the gaming wheel may be activated immediately after the dice roll outcome determination, following a display or animation on a user display, or other timing scheme. The gaming wheel activation may also occur upon a selection of a physical or virtual item, such as a launch button, a bash button, or similar feature. In some examples, the selection of the physical or virtual item may provide the appearance of user control or operation, while still maintaining randomness of the gaming event. For example, the selection may initiate the gaming wheel activation at a particular speed or timing, while the outcome of the gaming wheel may be the randomized outcome.

In some embodiments, the gaming wheel may be a standard roulette wheel, and the speed of the gaming wheel activation may correspond to a speed of a ball launch into a rim of the roulette wheel. The numerical dice roll outcome may also correspond to the wheel spin speed, a lighting effect on the gaming wheel, e.g., to simulate a spin, or another gaming wheel feature. In some examples, the dice roll may also correspond to a length of time that the spin wheel event occurs. This may include a wheel spin time, or a length of time before an outcome is determined.

In some examples, the dice roll may have additional gaming implications, such as determining a first multiplier that may be combined with the gaming wheel outcome.

At block 540, aspects may determine a randomized outcome of the gaming wheel. As described herein, gaming events may maintain randomness despite player input. Although players may control one or more aspects, such as a timing, speed, or force of the dice roll and/or the wheel spin, the events may remain randomized.

The dice shaker may be configured, for example, to toss the dice in a consistent, randomized method despite a speed, force, or timing of the dice throw or launch via the platform. In some examples, a random number generator may determine an outcome of the dice roll and the dice shaker may be configured to physically toss the dice to result in the randomized outcome.

The gaming wheel may also include one or more features to maintain randomness. For example, the gaming wheel may spin during a launch of a roulette ball and continue to spin at least until the roulette ball comes to rest. The spin speed may be a constant speed or a variable speed, to maintain randomness. As such, regardless of the speed or timing of the roulette ball launch, which may be determined by player input, as discussed herein, the outcome remains random.

In another example, a random number generator may determine an outcome of the gaming wheel, and the gaming wheel may be configured to display the outcome, regardless of player input and its effects on one or more aspects of the gaming wheel operation.

At block 550, aspects may apply a multiplier to the gaming event. The multiplier may correspond to a randomized outcome of at least one of the dice shaker and the gaming wheel. For example, the gaming wheel result may cause a multiplier to be applied to an outcome of the gaming event. In a particular example, the plurality of outcomes on the gaming wheel may represent a numerical multiplier, and the numerical multiplier may be applied to the gaming event. The gaming wheel outcome may be combined with the dice roll outcome in some manner, to combine the effects of the events. In an example, a first multiplier may be determined by the dice roll outcome, and a second multiplier may be determined by the gaming wheel outcome. As discussed herein, the dice roll outcome may also affect the operation of the gaming wheel, causing, for example, a number of balls to launch based on the dice roll outcome, a multiplier being applied to the gaming wheel based on the dice roll outcome, and the like. In other examples, one or more of the dice roll result and the gaming wheel result may cause additional actions, such as a free play, extra spin, dice throw, a side game, or other gaming action. Any of a variety of outcomes, multiplier combinations, and gaming events may result from the dice shaker and gaming wheel.

Such multipliers, bonuses, and gaming outcomes may vary based on a variety of factors and gaming considerations. They may also change to continually attract and entertain players, and for other business and profitability considerations. For example, gaming outcomes based on the dice shaker and gaming wheel combinations may vary based on a game type, a player (e.g., new player, VIP, etc.), a length of play time, a game cycle length, a time of day, and any of a variety of business and gaming considerations.

Embodiments may automatically resolve wagers associated with the gaming. The gaming apparatus may determine an outcome of the dice shaker and gaming wheel, determine any applicable multipliers, payouts, or gaming effects, and resolve any wagers and gaming events. Such determinations may occur automatically, in real-time. A player account, for example, may be linked to each wager associated with a gaming event, such that any funds won or lost may be transferred to/from the player account. Wager resolutions may utilize a wallet associated with respective player accounts. Wager resolutions may also occur automatically without any input or acceptance actions on the remote user device.

Any or all of the wager resolutions, dice roll outcomes, gaming wheel outcomes, and gaming event outcomes discussed herein may be provided on a display associated with the gaming apparatus. The display may be connected to or otherwise in communication with the gaming apparatus. The display may include an interactive touch screen and/or provide a graphical user interface.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

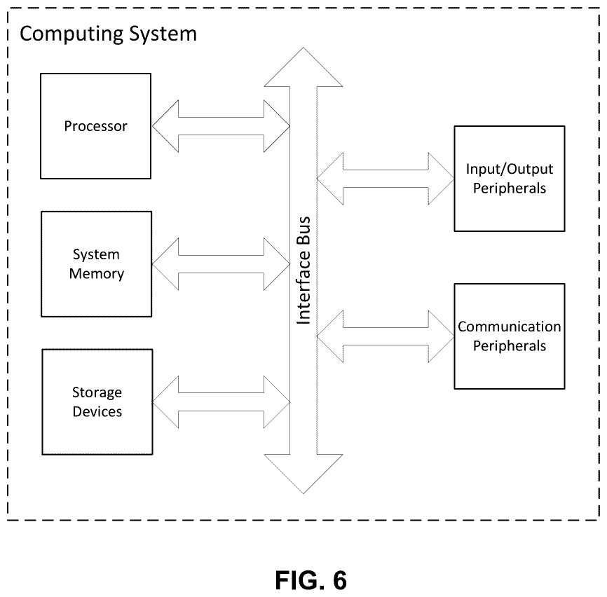

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 6 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a gaming system, comprises: a dice shaker configured to roll at least one die; a gaming wheel comprising a face displaying a plurality of gaming outcomes; and a gaming apparatus in communication with the dice shaker and the gaming wheel; a processor and at least one memory comprising instructions, which when executed by the processor, causes the gaming system to: in response to player input received at the gaming apparatus, activate the dice shaker to roll the at least one die and generate a roll outcome; activate the gaming wheel using a movement characteristic based on the roll outcome; and determine a randomized outcome of the gaming wheel.

In an embodiment, wherein the at least one memory comprises instructions, which when executed by the processor, causes the system to apply a multiplier to a gaming event at the gaming apparatus, the multiplier corresponding to the randomized outcome associated with the gaming wheel.

In an embodiment, wherein the dice shaker and the gaming wheel are positioned above the gaming apparatus.

In an embodiment, further comprising: a controller associated with the gaming apparatus, wherein the controller determines at least one of a timing and a force of the roll at the dice shaker.

In an embodiment, wherein the controller is a button.

In an embodiment, wherein the controller measures an activation force, and wherein the activation force determines the force of the roll.

In an embodiment, wherein the gaming wheel is a standard roulette wheel.

In an embodiment, wherein the standard roulette wheel spins at a constant speed to maintain randomness, and the constant speed corresponds to a roulette ball launch speed.

In an embodiment, wherein standard roulette wheel spins during a launch of the roulette ball, and at least until the roulette ball comes to rest.

In an embodiment, wherein the gaming apparatus further comprises a display displaying at least one of the roll outcome, and a gaming outcome.

In an embodiment, wherein the gaming apparatus is an individual player machine comprising a base section supporting the dice shaker and the gaming wheel.

In an embodiment, wherein the dice shaker and the gaming wheel are virtual, and wherein the dice shaker and gaming wheel are provided on a display associated with the gaming apparatus.

In an embodiment, wherein the gaming wheel comprises a plurality of pockets, wherein each pocket is associated with a gaming outcome.

In an embodiment, wherein the at least one memory comprises instructions, which when executed by the processor, causes the system to: launch a ball into the gaming wheel at a movement characteristic based on the roll outcome, wherein the gaming wheel spins to maintain randomness; and determine, by at least one sensor, a pocket in which the ball comes to rest, wherein the pocket determines the multiplier.

In an embodiment, wherein the sensor is at least one of an image sensor, a proximity sensor, a light sensor, a pressure sensor, and a radio frequency identification (RFID) sensor.

In an embodiment, a method for gaming, comprising: receiving, at a gaming apparatus, instructions to initiate a gaming event; activating a dice shaker configured to roll at least one die and generate a roll outcome, wherein the dice shaker is associated with the gaming apparatus; activating a gaming wheel using a movement characteristic based on the roll outcome, wherein the movement characteristic corresponds to at least one of a spin and a ball launch; and determining a randomized outcome of the gaming wheel.

In an embodiment, wherein activating the dice shaker automatically occurs during the gaming event.

In an embodiment, wherein activating the dice shaker occurs in response to receiving player input at the gaming apparatus.

In an embodiment, wherein the player input is received via a controller associated with the gaming apparatus.

In an embodiment, further comprising determining at least one of a timing and a force of the dice roll based on the player input.

In an embodiment, a non-transitory computer-readable storage medium comprising instructions stored thereon that cause a computing device to at least: receive, at a gaming apparatus, instructions to initiate a gaming event; activate a dice shaker configured to roll at least one die and generate a roll outcome, wherein the dice shaker is associated with the gaming apparatus; activate a gaming wheel using a movement characteristic based on the roll outcome, wherein the movement characteristic corresponds to at least one of a spin and a ball launch; and determine a randomized outcome of the gaming wheel.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A gaming system, comprising:
a dice shaker configured to roll at least one die;
a gaming wheel comprising a face displaying a plurality of gaming outcomes;
a gaming apparatus in communication with the dice shaker and the gaming wheel; and
a processor and at least one memory comprising instructions, which when executed by the processor, causes the gaming system to:
in response to player input received at the gaming apparatus, activate the dice shaker to roll the at least one die and generate a roll outcome;
activate the gaming wheel using a movement characteristic based on the roll outcome; and
determine a randomized outcome of the gaming wheel.

2. The gaming system of claim 1, wherein the at least one memory comprises instructions, which when executed by the processor, causes the system to apply a multiplier to a gaming event at the gaming apparatus, the multiplier corresponding to the randomized outcome associated with the gaming wheel.

3. The gaming system of claim 1, further comprising:
a controller associated with the gaming apparatus, wherein the controller determines at least one of a timing and a force of the roll at the dice shaker.

4. The gaming system of claim 3, wherein the controller is a button.

5. The gaming system of claim 3, wherein the controller measures an activation force, and wherein the activation force determines the force of the roll.

6. The gaming system of claim 1, wherein the gaming wheel is a standard roulette wheel.

7. The gaming system of claim 6, wherein the standard roulette wheel spins at a constant speed to maintain randomness, and the constant speed corresponds to a roulette ball launch speed.

8. The gaming system of claim 7, wherein standard roulette wheel spins during a launch of the roulette ball, and at least until the roulette ball comes to rest.

9. The gaming system of claim 1, wherein the gaming apparatus further comprises a display displaying at least one of the roll outcome, and a gaming outcome.

10. The gaming system of claim 1, wherein the gaming apparatus is an individual player machine comprising a base section supporting the dice shaker and the gaming wheel.

11. The gaming system of claim 1, wherein the dice shaker and the gaming wheel are virtual, and wherein the dice shaker and the gaming wheel are provided on a display associated with the gaming apparatus.

12. The gaming system of claim 1, wherein the gaming wheel comprises a plurality of pockets, and wherein each pocket is associated with a gaming outcome.

13. The gaming system of claim 12, wherein the at least one memory comprises instructions, which when executed by the processor, causes the system to:
launch a ball into the gaming wheel at a speed based on the roll outcome, wherein the gaming wheel spins to maintain randomness; and
determine, by at least one sensor, a pocket in which the ball comes to rest, wherein the pocket determines the multiplier.

14. The gaming system of claim 13, wherein the sensor is at least one of an image sensor, a proximity sensor, a light sensor, a pressure sensor, and a radio frequency identification (RFID) sensor.

15. A method for gaming, comprising:
receiving, at a gaming apparatus, instructions to initiate a gaming event;
activating a dice shaker configured to roll at least one die and generate a roll outcome, wherein the dice shaker is associated with the gaming apparatus;
activating a gaming wheel using a movement characteristic based on the roll outcome, wherein the movement characteristic corresponds to at least one of a wheel spin and a ball launch; and
determining a randomized outcome of the gaming wheel.

16. The method of claim 15, wherein activating the dice shaker automatically occurs during the gaming event.

17. The method of claim 15, wherein activating the dice shaker occurs in response to receiving player input at the gaming apparatus.

18. The method of claim 17, wherein the player input is received via a controller associated with the gaming apparatus.

19. The method of claim 18, further comprising: determining at least one of a timing and a force of the dice roll based on the player input.

20. A non-transitory computer-readable storage medium comprising instructions stored thereon that cause a computing device to at least:
receive, at a gaming apparatus, instructions to initiate a gaming event;
activate a dice shaker configured to roll at least one die and generate a roll outcome, wherein the dice shaker is associated with the gaming apparatus;
activate a gaming wheel using a movement characteristic based on the roll outcome, wherein the movement characteristic corresponds to at least one of a spin and a ball launch; and
determine a randomized outcome of the gaming wheel.
